(19) United States
(12) Patent Application Publication
(10) Pub. No.: US 2008/0116706 A1
(43) Pub. Date: May 22, 2008

(54) Hook elastic body protective device for heavy object crane hook

(76) Inventor: Steven Hung, Taichung County (TW)

Correspondence Address: TROXELL LAW OFFICE, PLLC, SUITE 1404, 5205 LEESBURG PIKE, FALLS CHURCH, VA, 22041, US

(21) Appl. No.: 11/974,764

(22) Filed: Nov. 20, 2006

(51) Int. Cl. B66C 1/22

(52) U.S. Cl. 294/131

(57) ABSTRACT

A hook elastic body protective device for heavy object crane hook, wherein a pair of opposite and rear-inclined protection boards with large head and small lower part are fixed at rear side of hook by fixing bolt through bolt holes made on protection boards and through hole respectively made at lower two sides of top hole of shackle and rear side of hook; basing on such structure, elastic body for buckle mounted inside of hook can fold inward to open hook and retreat into two protection boards to hide, elastic body is free of damage by external collision, so that it is easy to use and use life of crane hook can be extended accordingly.

### BACKGROUND OF THE INVENTION

1) Field of the Invention

This invention relates to a hook elastic body protective device for heavy object crane hook, which fixes a pair of rear-inclined protection boards with large head and small lower part at two sides of rear section within its moving scope basing on the elastic body mounted at lower section of shackle and internal segment of hook to open or close hook by inside folding or retreating, so that elastic body couldn't be collided and broken during suspending.

2) Description of the Prior Art

Usually, hook 21 made at lower part of shackle 2 of heavy object crane hook (please refer to FIG. 1) is to hook hanging hole at top of work piece or connected chain and hanging rope, however, mobile elastic body 22 set inside of hook is to close hook 21, as work piece is hung and pushed back elastic body 22 which rebounds back and close hook after work piece is hung, so that work piece couldn't drop off hook, it will be safe during suspending.

However, since the traditional elastic body 22 is completely exposed, only its upper part bolted with top of hook 21 is movable, so, the elastic body may be collided and the bolted part might be distorted or loose during suspending or moving, thereby, hook 21 is difficult to open or close while hanging object next time, this is key factor why such kind of heavy object must get repaired or replaced.

### SUMMARY OF THE INVENTION

Key purpose of this invention is to provide hook elastic body protective device for heavy object crane hook, wherein a pair of rear-inclined protection boards with large head and small lower part are fixed at two sides of rear section within its moving scope basing on the elastic body mounted at lower section of shackle and internal segment of hook to open or close hook by inside folding or retreating, which can effectively protect elastic body and its upper bolted parts from collision and extend use life of heavy object crane hook under the precondition no to impact hook gap.

The second purpose of this invention is to provide hook elastic body protective device for heavy object crane hook, wherein protection boards, as external added fixture device, are mounted by fixing bolt through the through holes made at lower two sides of top hole of upper shackle, namely, rear side of hook; you can modify crane hook without restructuring the original structure, so, it is economic and beneficial.

### BRIEF DESCRIPTION OF THE DRAWINGS

FIG. 1 is the exploded view of prior art.

FIG. 2 is the exploded and disassembled view of structure of this invention.

FIG. 3 is the exploded and combined view of structure of this invention.

FIG. 4-A is the exploded view of close hook of structure of this invention.

FIG. 4-B is the exploded view of structure of this invention to open hook.

### DETAILED DESCRIPTION OF THE PREFERRED EMBODIMENTS

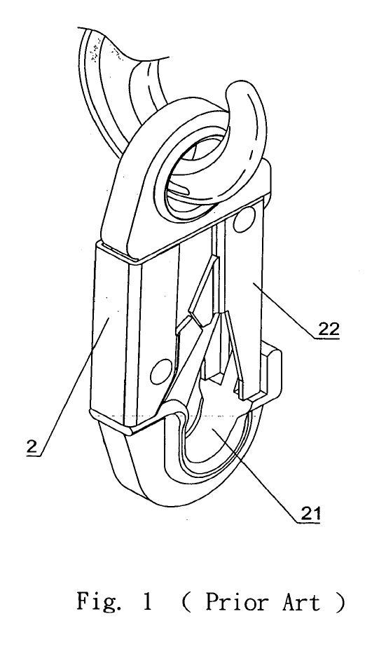

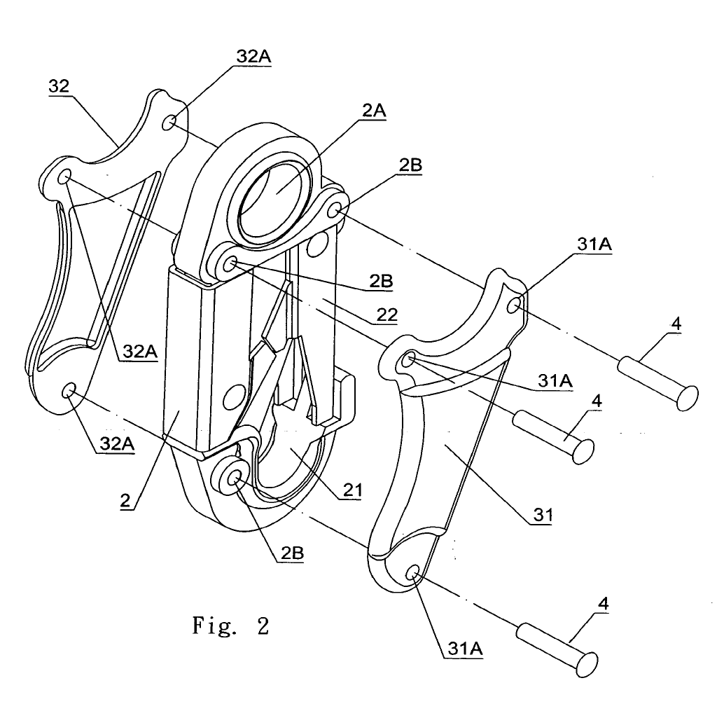

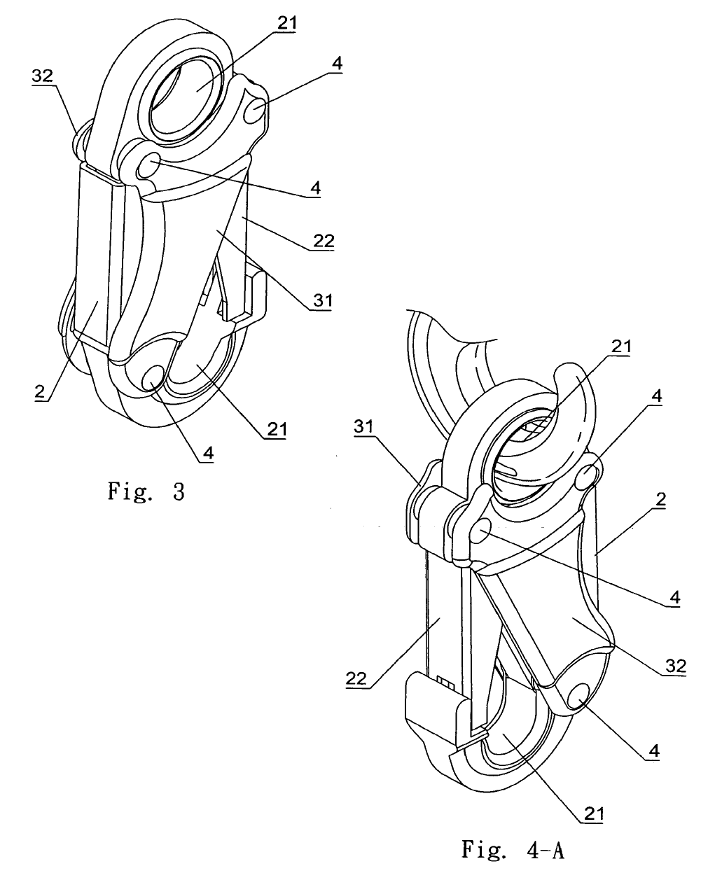

The embodiments and examples of this invention are hereby described with brief drawings in the following, and please also refer to FIG. 1 and FIG. 2. A pair of opposite and rear-inclined protection boards 31, 32 with large head and small lower part are fixed at rear side periphery of hook 21 by fixing bolt 4 through bolt holes 31A,32A made on protection boards 31 32 and through hole 2B respectively made at lower two sides of top hole 2A of shackle 2, namely, rear side of hook 21.

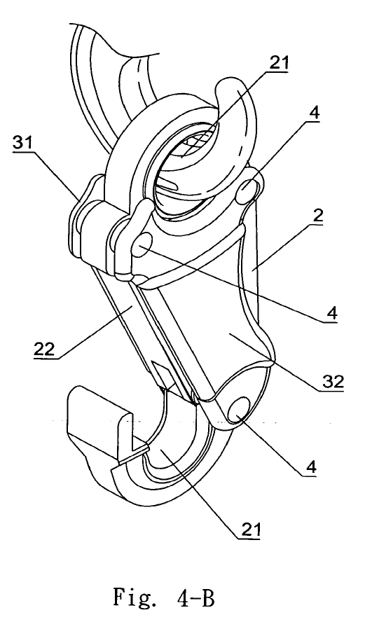

Basing on such structure, elastic body 22 for buckle (see FIG. 4-A) mounted inside of hook 21 can fold inward to open hook 21 and retreat into two protection boards 31 and 32 to hide (see FIG. 4-B), so that elastic body 22 is free of damage by external collision or properly bolted, moreover, elastic body 22 is easy to use and use life of crane hook may also be extended accordingly.

To sum up all above descriptions, this invention indeed can extend use life of heavy object crane hook that answers to the requirements of a new patent.

What is claimed is:

1. A hook elastic body protective device for heavy object crane hook, wherein a pair of opposite and rear-inclined protection boards with large head and small lower part are fixed at rear side of hook by fixing bolt through bolt holes made on protection boards and through hole respectively made at lower two sides of top hole of shackle and rear side of hook gap; basing on such structure, elastic body for buckle mounted inside of hook can fold inward to open hook and retreat into two protection boards to hide, so that elastic body is free of damage by external collision.
